(19) United States
(12) Patent Application Publication
(10) Pub. No.: US 2017/0217155 A1
(43) Pub. Date: Aug. 3, 2017

(54) PRINTING MACHINES WITH MANUAL PRE-REGISTERING SYSTEMS

(71) Applicant: OMET S.r.l., LECCO (IT)

(72) Inventor: Amerigo Manzini, LECCO (IT)

(73) Assignee: OMET S.r.l., LECCO (IT)

(21) Appl. No.: 15/329,259

(22) PCT Filed: Jul. 27, 2015
(86) PCT No.: PCT/IB2015/055671

§ 371 Date: Jan. 26, 2017

(30) Foreign Application Priority Data
Jul. 30, 2014 (IT) TO2014A000606

(51) Int. Cl. B41F 27/10

(52) U.S. Cl. CPC B41F 27/105; B41P 2227/30; B41P 2233/13

(57) ABSTRACT

Printing machines are provided which include a plurality of printing units, each including a cliché-carrying cylinder rotatably mounted about a respective axis of rotation (x) and a cliché fixed to the cliché-carrying cylinder in a given angular position with respect to the latter. The cliché-carrying cylinder of each printing unit has at least one reference mark (N) intended to be aligned with a given reference direction (z) to ensure correct angular positioning of this cliché-carrying cylinder with respect to the cliché-carrying cylinders of the other printing units. Each printing unit comprises a laser source adapted to generate a light beam directed along the reference direction (z) of this printing unit and towards the cliché-carrying cylinder of this printing unit, so that it is easier to perform the operation of aligning the reference mark (N) on the cliché-carrying cylinder with the reference direction (z).

The present invention relates to a printing machine provided with a manual pre-registering system, as specified in the preamble of independent claim 1.

In printing machines the pre-registering operation is typically performed by the operator by suitably adjusting the cliché-carrying cylinder of each printing unit about its axis of rotation to ensure correct superimposition of the images printed by the various printing units of the machine on the paper web which is fed through the machine. This operation is usually time-consuming and complicated, in particular if it is performed by operators with little experience and/or ability, and moreover generates a considerable amount of waste material.

A printing machine provided with a manual pre-registering system according to the preamble of independent claim 1 is known from U.S. Pat. No. 4,860,650 A. According to this known solution, each printing unit of the machine comprises a mechanical indicator designed to provide a visual indication of a reference direction to which a reference mark provided on the cliché-carrying cylinder of the printing unit must be aligned by the operator.

A first drawback of this known solution is that whenever the cliché-carrying cylinder must be replaced, either with a cliché-carrying cylinder having the same format or with a cliché-carrying cylinder having a different format, it is required to remove the mechanical indicator, or to modify its orientation, in order to allow removal of the cliché-carrying cylinder to be replaced and assembly of the new cliché-carrying cylinder. Moreover, in order to ensure a certain degree of precision, the mechanical indicator must be positioned as close as possible to the lateral surface of the cliché-carrying cylinder on which the reference mark is provided. Therefore, in the event of a change in format of the cliché-carrying cylinder, the mechanical indicator of each printing unit must every time be suitably repositioned so as to be adapted to the diameter of the new cliché-carrying cylinder, this inevitably resulting in longer times needed to carry out the pre-registering operation.

A further drawback of this known solution is that the visual indication given by the mechanical indicator to the operator varies with a variation in the observation point of the operator, since the mechanical indicator cannot be in contact with the cliché-carrying cylinder, but must be kept at a certain—albeit small—distance from the latter. Therefore, the precision with which the pre-registering operation is carried out depends on the ability of the operator to adopt the same observation point for all the printing units of the machine.

It is therefore an object of the present invention to provide a printing machine with a manual pre-registering system which allows the pre-registering operation to be performed more rapidly and precisely than in the prior art.

This and other objects are fully achieved according to the present invention by means of a printing machine having the features specified in the accompanying independent claim 1.

Further advantageous embodiments of the invention are the subject of the dependent claims, the contents of which are to be understood as forming an integral and complementary part of the following description.

In short, the invention is based on the idea of using, as indicator means adapted to provide a visual indication of the reference direction for each printing unit of the machine, a light source, in particular a laser source, adapted to generate a light beam directed along the reference direction and towards the cliché-carrying cylinder of the respective printing unit. Owing to the fact that the reference direction is indicated, for each printing unit of the machine, by the light beam generated by a respective light source positioned at a certain distance from the cliché-carrying cylinder, it is no longer necessary to remove or change the orientation of the indicator in the event of the replacement of the cliché-carrying cylinder, nor reposition the indicator in the event of a change in format of the cliché-carrying cylinder, with consequent speeding-up of the pre-registering operation.

Further characteristics and advantages of the present invention will become clear from the following detailed description, given purely by way of a non-limiting example with reference to the accompanying drawings, in which:

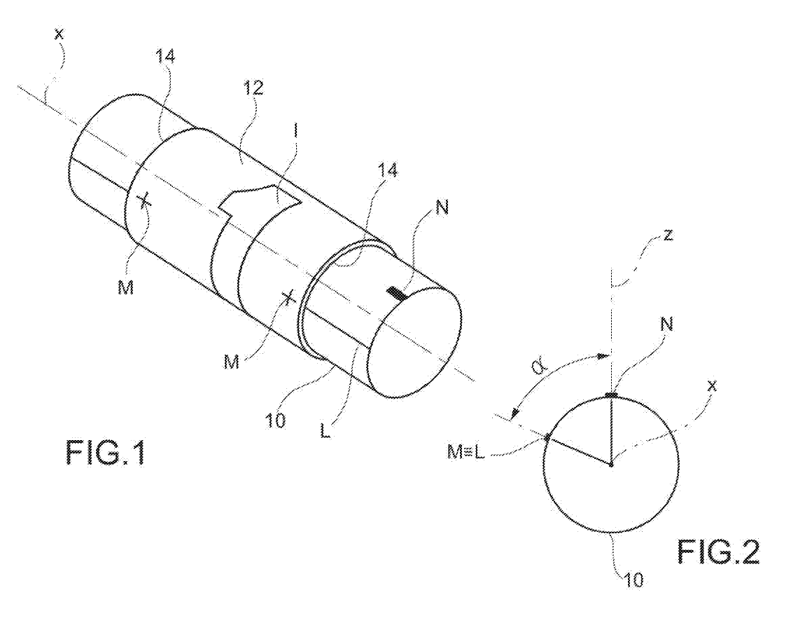

FIG. 1 is a perspective view which shows schematically a cliché-carrying cylinder used on a printing machine with manual pre-registering system according to the present invention;

FIG. 2 is a side view of the cliché-carrying cylinder of FIG. 1;

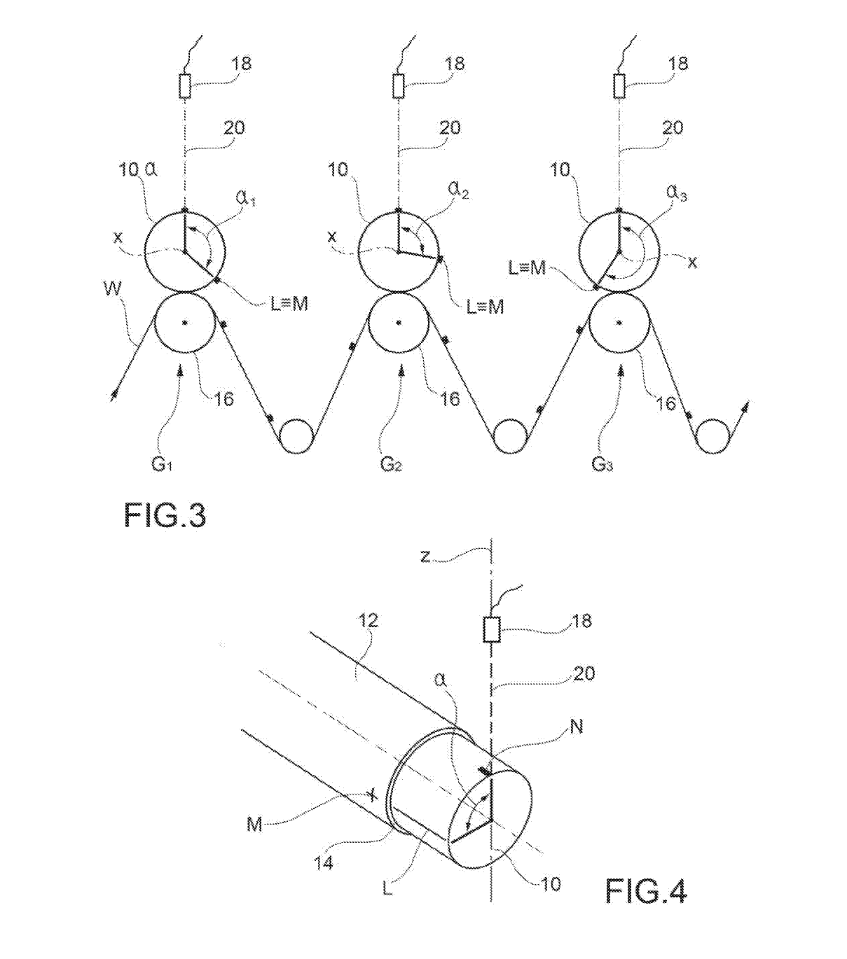

FIG. 3 is a side view which shows schematically a portion of a printing machine with manual pre-registering system according to the present invention; and

FIG. 4 is a perspective view which shows schematically a cliché-carrying cylinder of the printing machine of FIG. 3 with an associated indicator device.

FIG. 1 of the attached drawings shows schematically a cliché-carrying cylinder 10 on which a cliché 12 adapted to reproduce an image I on a paper web is mounted. In order to ensure correct positioning of the cliché 12 on the respective cliché-carrying cylinder 10, the cliché-carrying cylinder 10 has on its lateral surface a first reference mark L, such as for example a straight line extending along a direction parallel to the axis of rotation (indicated x) of the cliché-carrying cylinder 10, and the cliché 12 has one or more reference marks M, preferably two reference marks which are arranged in the vicinity of axially opposite edges 14 of the cliché and are aligned with each other along a direction parallel to the axis of rotation of the cliché-carrying cylinder 10, said reference marks M being intended to be aligned with the first reference mark L on the cliché-carrying cylinder 10 in order to define a given relative angular position of the cliché 12 with respect to the cliché-carrying cylinder 10 about the axis of rotation x. Each cliché-carrying cylinder 10 must be positioned, at the start of the printing operation, in a predetermined angular position (which may be different from cylinder to cylinder) about its axis of rotation x.

With reference in particular to FIG. 2 of the attached drawings, which shows a side view of the cliché-carrying cylinder 10 of FIG. 1, in the aforementioned predetermined angular position of the cliché-carrying cylinder 10, the first reference mark L provided on the lateral surface of this cylinder will be oriented at a certain angle α with respect to a reference direction z, for example the vertical direction. In order to allow easy identification of the predetermined angular position of each cliché-carrying cylinder 10, and therefore easy positioning of each cliché-carrying cylinder 10 in this position during the pre-registering operation, each cliché-carrying cylinder 10 has, for example on its lateral surface, a second reference mark N angularly offset by the aforementioned angle α with respect to the first reference mark L. In this way, by orienting each cliché-carrying cylinder 10 about its axis of rotation x so that its second reference mark N is aligned with the reference direction z, the cliché-carrying cylinder 10, and therefore the associated cliché 12, will be oriented at the desired angle α with respect to the reference direction z.

With reference now to FIG. 3, a printing machine according to the present invention includes a plurality of printing units (three of which are schematically shown in FIG. 3 and are indicated G₁, G₂ and G₃, respectively), each of which comprises a cliché-carrying cylinder 10 like the one described above with reference to FIGS. 1 and 2 and an impression cylinder 16 kept in contact with the cliché 12 mounted on the cliché-carrying cylinder 10.

A web W of paper (or of other printing material), suitably fed by feeding means of per-se-known type, is moved forward in succession between the cliché-carrying cylinder 10 and the impression cylinder 16 of the printing units G₁, G₂, G₃, whereby the image reproduced on the cliché 12 of the cliché-carrying cylinder 10 of each printing unit G₁, G₂, G₃ is transferred each time onto the paper web W.

As already mentioned above with reference to FIGS. 1 and 2, the cliché-carrying cylinder 10 of each printing unit G₁, G₂, G₃ can be manually oriented about its axis of rotation x so as to be positioned, at the start of printing, with a given angular orientation about the axis of rotation x with respect to the cliché-carrying cylinders 10 of the other printing units. Moreover, the cliché-carrying cylinder 10 of each printing unit G₁, G₂, G₃ has on its lateral surface the second reference mark N which is positioned in such a way that, when the second reference mark N is aligned along the reference direction z, the cliché-carrying cylinder 10 is correctly oriented about its axis of rotation x. In FIG. 3, the angular distance (about the axis of rotation x) of the first reference mark L from the second reference mark N of the cliché-carrying cylinder 10 of the printing unit G₁ is indicated α₁, the angular distance of the first reference mark L from the second reference mark N of the cliché-carrying cylinder 10 of the printing unit G₂ is indicated α₂, and finally the angular distance of the first reference mark L from the second reference mark N of the cliché-carrying cylinder 10 of the printing unit G₃ is indicated α₃. As shown in FIG. 3, the angles α₁, α₂ and α₃ will typically be different from each other, so that each cliché-carrying cylinder will have to be mounted on a specific printing unit, but it is in any case possible that the angular distance of the first reference mark from the second reference mark be the same for two or more cliché-carrying cylinders.

The operation of pre-registering the printing machine is performed by the operator by manually orienting each cliché-carrying cylinder 10 about its axis of rotation x so as to align the second reference mark N with the reference direction z. For each printing unit G₁, G₂, G₃ the reference direction z is visually indicated to the operator by a respective indicator device 18. In order to carry out the pre-registering operation, therefore, the operator must merely rotate each cliché-carrying cylinder 10 about is axis of rotation x until the second reference mark N is aligned with the reference direction z indicated by the indicator device 18.

According to the invention, the indicator device 18 is a light source, preferably a laser source, which is arranged at a certain distance from the cliché-carrying cylinder 10 and is adapted to emit towards the respective cliché-carrying cylinder 10 a light beam 20 directed along the reference direction z. As is clear, the use of a light source as indicator means allows the indication of the reference direction to be projected directly onto the cylinder. This indication remains always the same, irrespective of the observation point of the operator. Moreover, since the light source may also be arranged far from the cylinder, without thereby adversely affecting the precision of the pre-registering system, it does not represent an obstacle during the cylinder replacement operations and therefore does not require any removal or displacement during these operations. The manual pre-registering system according to the invention allows therefore the pre-registering operations to be performed more rapidly and precisely than in the prior art.

Naturally, the principle of the invention remaining unchanged, the embodiments and the constructional details may vary widely from those described and illustrated purely by way of non-limiting example.

1-2. (canceled)

3. A printing machine comprising a plurality of printing units (G₁, G₂, G₃), each including a cliché-carrying cylinder rotatably mounted about a respective axis of rotation (x) and a cliché fixed to the cliché-carrying cylinder,
wherein the cliché-carrying cylinder of each printing unit (G₁, G₂, G₃) has a first reference mark (L) adapted to be aligned with a corresponding reference mark (M) provided on the cliché to ensure correct angular positioning of the cliché relative to the cliché-carrying cylinder, and a second reference mark (N) angularly offset by a given angle (α₁, α₂, α₃) with respect to the first reference mark (L) about the axis of rotation (x) of said cliché-carrying cylinder, said second reference mark (N) being designed to be aligned with a given reference direction (z) to ensure correct angular positioning of said cliché-carrying cylinder with respect to the cliché-carrying cylinders of the other printing units (G₁, G₂, G₃), and
wherein each printing unit (G₁, G₂, G₃) further comprises an indicator element for providing a visual indication of said reference direction (z),
wherein said indicator element comprises a light source adapted to generate a light beam directed along the reference direction (z) of the respective printing unit (G₁, G₂, G₃) and towards the cliché-carrying cylinder of the respective printing unit (G₁, G₂, G₃).

4. The printing machine of claim 3, wherein the light source comprises a laser.
